(19) United States
(12) Patent Application Publication
(10) Pub. No.: US 2008/0270898 A1
(43) Pub. Date: Oct. 30, 2008

(54) Methods and Apparatus for Dynamically Updating a Graphical User Interface, to Focus on a Production Display or a Debug Display

(76) Inventors: Kristin Petersen, Clifton Park, NY (US); Carli Connally, Fort Collins, CO (US)

Correspondence Address: Gregory W. Osterloth;Holland & Hart, LLP, P.O. Box 8749, Denver, CO, 80201, US

(21) Appl. No.: 11/740,708

(22) Filed: Apr. 26, 2007

(51) Int. Cl. G06F 3/00

(52) U.S. Cl. 715/700

(57) ABSTRACT

In one embodiment, a computer automatically determines whether one or more debug indicators, each of which is associated with one or more of a plurality of test data items, indicate 1) that one or more of the test data items pertain to a production mode, or 2) that one or more of the test data items pertain to a debug mode. Depending on whether one or more of the debug indicators indicate that a particular one of the test data items pertains to the production mode or the debug mode, the particular one of the test data items is allocated to a production display or a debug display of a graphical user interface (GUI). Then, depending on whether a next test data item to be displayed pertains to the production mode or the debug mode, the GUI is dynamically updated to focus on the production display or the debug display. Other embodiments are also disclosed.

### BACKGROUND

When testing circuit devices such as system-on-a-chip (SOC) devices, both production tests and debug tests may be executed. As defined herein, “production tests” are those tests that are executed during the ordinary course of device testing, while “debug tests” are those tests that are executed for the purpose of extracting additional test data for the purpose of debugging a problem, or monitoring a trend, seen in one or more tested devices. Debug tests can also include tests that are used to debug the operation or effectiveness of a test itself.

Typically, the results of production tests and debug tests are co-mingled. As a result, it is often difficult for a user to determine whether any particular result is a production result or a debug result. Also, software that calculates statistics or performs other sorts of data analysis treats all of the test results the same. Thus, a statistic that is designed to track the outcome of a production test, executed on a large number of devices, could be skewed by a series of debug tests, executed on only one device.

### BRIEF DESCRIPTION OF THE DRAWINGS

Illustrative embodiments of the invention are illustrated in the drawings, in which:

FIG. 1 illustrates an exemplary computer-implemented method for dynamically updating a graphical user interface, to focus on a production display or a debug display;

FIGS. 2 & 3 illustrate an exemplary graphical user interface (GUI) via which the method shown in FIG. 1 may be implemented.

### DETAILED DESCRIPTION

As a preliminary manner, it is noted that, in the following description, like reference numbers appearing in different drawing figures refer to like elements/features. Often, therefore, like elements/features that appear in different drawing figures will not be described in detail with respect to each of the drawing figures.

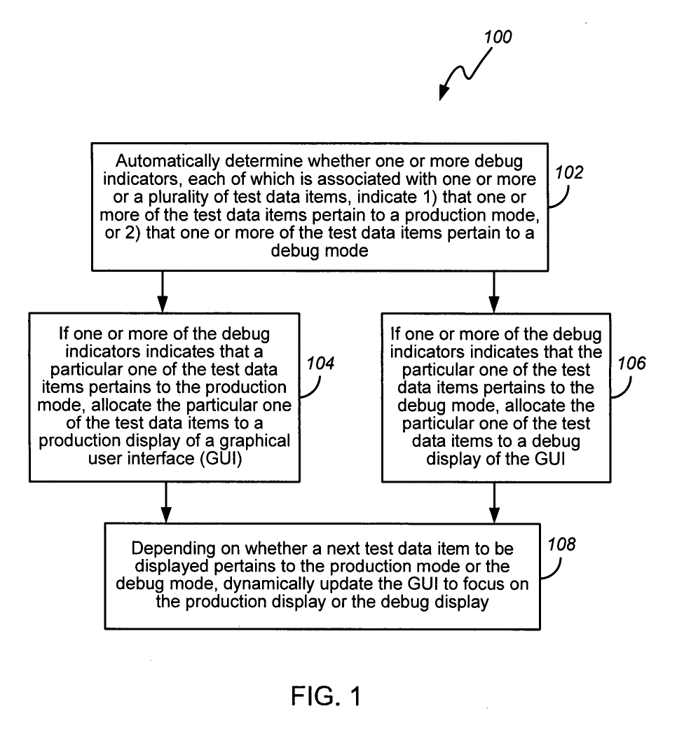

In accord with one embodiment of the invention, FIG. 1 illustrates a computer-implemented method 100 that operates on a plurality of test data items and one or more debug indicators. In one embodiment, the test data items may pertain to tests of a system-on-a-chip (SOC) device, such as tests that have been executed by the V93000 SOC tester distributed by Verigy Ltd. However, the test data items could also pertain to tests that are executed by other sorts of testers, or tests that are executed on other sorts of circuit devices. In some cases, the test data items may be provided by, or derived from, one of the data formatters disclosed in the United States patent application of Connally, et al. entitled “Apparatus for Storing and Formatting Data” (Ser. No. 11/345,040).

The debug indicators may also take various forms. In some cases, one or more of the debug indicators may comprise tags that are associated with individual ones of the test data items. Alternately, or additionally, one or more of the debug indicators may comprise contextual information that is interspersed with a sequential order in which the test data items are generated or received. Regardless of their form, each of the debug indicators is 1) associated with one or more of the plurality of test data items, and 2) specifies or suggests whether one or more of the test data items pertain to a production test mode or a debug test mode.

Returning to the method 100, the method begins with a computer automatically determining whether one or more of the afore-mentioned debug indicators indicate 1) that one or more of the test data items pertain to a production mode, or 2) that one or more of the test data items pertain to a debug mode. See, block 102. If one or more of the debug indicators indicates that a particular one of the test data items pertains to the production mode, the test data item is allocated to a production display of a graphical user interface (GUI). See, block 104. However, if one or more of the debug indicators indicates that the particular one of the test data items pertains to the debug mode, the test data item is allocated to a debug display of the GUI. See, block 106. By way of example, a test data item may be allocated to a display by forwarding it to a data store or memory from which a particular display (production or debug) is derived, or by immediately translating the test data item into display data for a particular display (production or debug).

The method 100 continues with a dynamic update of the GUI, to focus on either the production display or the debug display, depending on whether a next test data item to be displayed pertains to the production mode or the debug mode. See, block 108.

Of note, the steps of the method 100 may take orders other than those shown in FIG. 1. However, it is preferred that the method's steps 102, 104, 106, 108 be performed repetitively, and substantially in parallel.

The method 100 can be advantageous in that production test data and debug test data is separately displayed, making it easier to determine what the data means, identify trends, et cetera. In the case of debug data, there will typically be much less data to review, making it easier to determine what the debug data means.

The method 100 can also be advantageous in that a user is always shown the most recently acquired or processed test data items. And, the user is shown the most recent test data items via a display that segregates production test data from debug test data.

The method 100 shown in FIG. 1 may be implemented by means of computer-readable code stored on computer-readable media. The computer-readable media may include, for example, any number or mixture of fixed or removable media (such as one or more fixed disks, random access memories (RAMs), read-only memories (ROMs), or compact discs), at either a single location or distributed over a network. The computer readable code will typically comprise software, but could also comprise firmware or a programmed circuit.

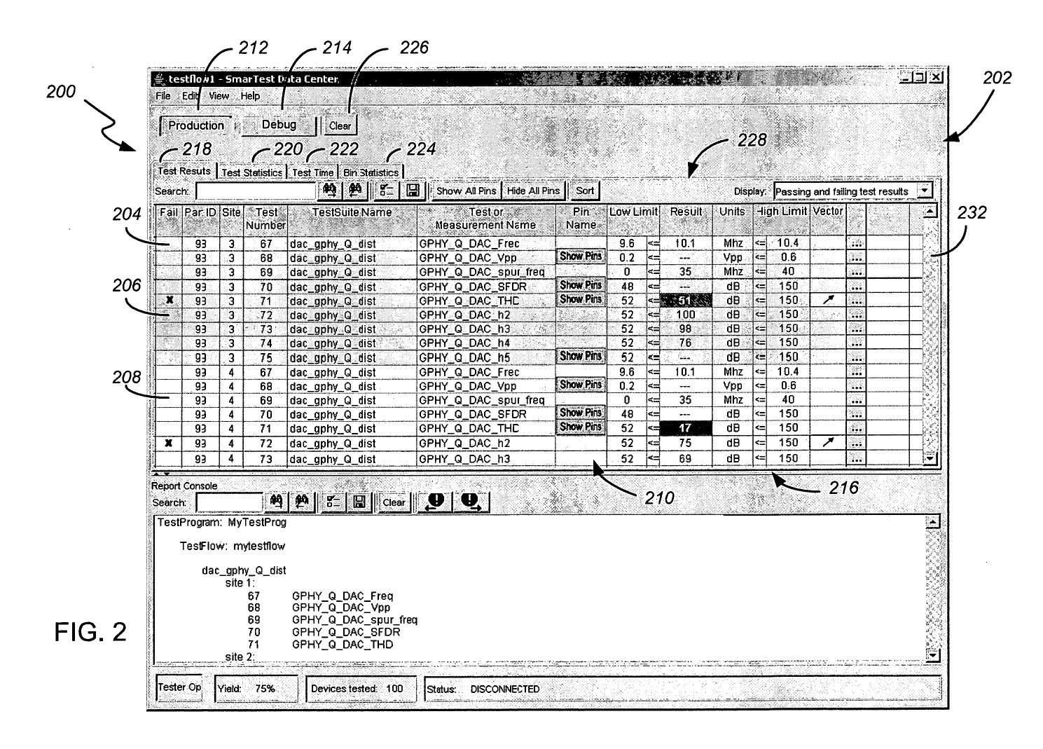

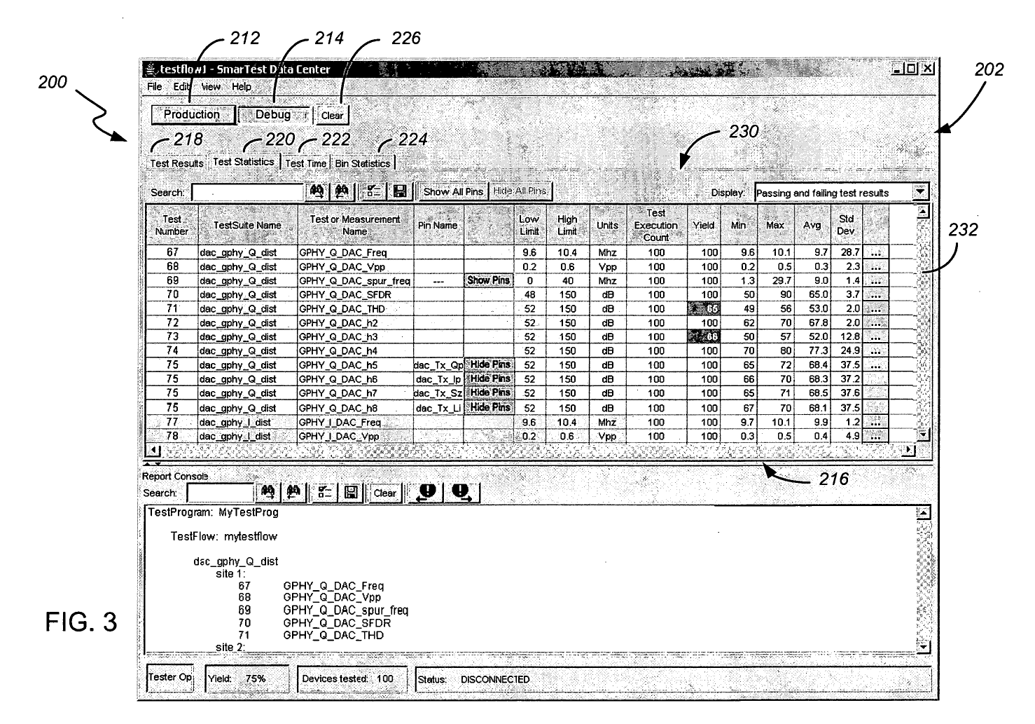

FIG. 2 illustrates an exemplary window (or screen) 202 of a GUI 200 via which the method 100 may be implemented. As shown, a plurality of test data items, such as test data entries 204, 206 and 208, may be displayed via the window 202. By way of example, each test data entry 204, 206, 208 comprises three test result identifiers, including: a “Test Number”, a “Test or Measurement Name”, and a “TestSuite Name” that identifies a test suite to which the test name and number belong. In addition, each test data entry 204, 206, 208 comprises: information identifying the test resources via which a test result was acquired (e.g., a test “Site” number), and information identifying the device and pin for which a test result was acquired (e.g., a device “Part ID”, and a device “Pin Name”). Each test data entry 204, 206, 208 also comprises one or more test results, which may take forms such as a value in a “Result” field and/or a check in a “Fail” field (e.g., for those tests that have failed). For measurement-type test results, “Unit”, “Low Limit” and “High Limit” fields may also be populated.

Preferably, the window 202 is displayed during execution of a plurality of tests on which the test data entries 204, 206, 208 are based (i.e., during test of a device under test). New test results can then be displayed via the window as they are acquired, and a user can be provided a “real-time” display of test results. Alternately, device testing can be completed, and a log of test results can be saved to volatile or non-volatile storage (e.g., memory or a hard disk). The test results can then be read and displayed in succession via the window 202 (i.e., not in real-time). Typically, the test data entries 204, 206, 208 that are displayed at any one time represent only some of the test data entries or items that are generated during execution of a plurality of tests. One or more mechanisms such as a scroll bar 232 may be provided to allow a user to navigate to different test data entries or items.

By way of example, FIG. 2 illustrates a production display 228 (i.e., a display in which the test data entries 204, 206, 208 pertain to production test data). A graphical button 212 labeled “Production” is associated with the production display 228 and serves as both a production mode identifier and selector. Similarly, a graphical button 214 labeled “Debug” is associated with a debug display 230 (FIG. 3) and serves as both a debug mode identifier and selector. In one embodiment of the GUI 200, the buttons 212, 214 are displayed via the window 202 at all times.

As a result of FIG. 2 illustrating a production display 228, the “Production” button 212 is shown depressed, and the “Debug” button 214 is shown un-depressed. If a user graphically clicks on the “Debug” button 214, the window 202 may be updated to show the “Debug” button 214 depressed and the “Production” button 212 un-depressed (see, FIG. 3). In addition, the GUI 200 may be updated to focus on a debug display 230. When the GUI 200 is updated, the test data entries 204, 206, 208 shown in the common fill area 216 may be replaced with test data entries pertaining to a debug mode. Alternately, the production display 228 and debug display 230 could comprise respective and different windows of the GUI 200, and an update of the GUI 200 to focus on the production display 228 or the debug display 230 could result in a pertinent one of the windows being launched and/or brought to the front of the GUI (i.e., overlaid over the other window).

Although the “Production” and “Debug” buttons 212, 214 are shown in FIG. 2 to serve as both mode identifiers and mode selectors, their identifying and selecting functions could alternately be provided via separate sets of buttons. Or, the buttons 212, 214 could be replaced or supplemented by, for example: graphical tabs, check boxes, pull-down menu selections, pop-up menu selections, graphical toolbar icons, or dialog box options. The buttons 212, 214 could also take the form of a single mechanism, such as a button, that is dynamically reconfigured to allow a user to select whichever mode is not currently selected (i.e., production or debug).

Also, in addition to (or instead of) one of the buttons 212, 214 being shown depressed to indicate which of the production display 228 or debug display 230 is currently displayed, the buttons 212, 214 or other identification/selection mechanisms could be distinguished in other ways, such as by use of contrasting colors, highlighting or bolded text labels.

In addition to providing graphical buttons 212, 214 for selecting the production display 228 or debug display 230, the GUI 200 provides a plurality of graphical tabs 218, 220, 222, 224 labeled “Test Results”, “Test Statistics”, “Test Time” and “Bin Statistics”. These tabs 218, 220, 222, 224 are subservient to the mode selector buttons 212, 214, such that selection of one of the mode selector buttons 212, 214 results in the tabs 218, 220, 222, 224 being alternately configured to access production test data or debug test data. Similarly, test data items pertaining to 1) the production mode or the debug mode, and 2) one of the tabs 218, 220, 222 or 224, are swapped into the common fill area 216. Thus, for example, selection of the “Test Statistics” tab 220 while the “Debug” button 212 is depressed would result in test statistics pertaining to the debug mode being displayed in the common fill area 216, as shown in FIG. 3. That is, test statistics based solely on debug data would be displayed in the common fill area 216.

The precise format and content of the data which is displayed after user selection of one of the tabs 220, 222 or 224 is beyond the scope of this disclosure.

In accord with the method 100 (FIG. 1), the GUI 200 may be dynamically updated to focus on the production display 228 shown in FIG. 2, or the debug display shown in FIG. 3, depending on whether a next test data item to be displayed pertains to a production mode or a debug mode. As part of this dynamic updating of the GUI 200, the states of the mode selector buttons 212, 214, and the data which the tabs 218, 220, 222 and 224 access, are also dynamically updated. In one embodiment, a user's graphical click on one of the mode selector buttons 212, 214 1) causes the GUI 200 to update to focus on a respective one of the production display or the debug display, and 2) causes dynamic updates of the GUI 200 to cease. That is, when the GUI 200 has been configured to automatically swap production or debug data into the common fill area 216, a user's subsequent click on one of the mode selector buttons 212, 214 causes the GUI 200 to enter a manual mode, where, for example, debug data is not displayed unless the user manually clicks on the debug mode selector button 214.

As further shown in FIG. 2, each of the test data entries 204, 206, 208 may be displayed as a line of a table 210, with different lines of the table corresponding to different ones of the test data entries 204, 206, 208. For purposes of this description, a “table” is defined to be either an integrated structure wherein data is displayed in tabular form, or multiple structures that, when displayed side-by-side, enable a user to review information in rows and columns.

Similarly to the mode selector buttons 212, 214, the tabs 218, 220, 222 and 224 could also be implemented in other ways. For example, the tabs 218, 220, 222 and 224 could be implemented via any or all of: graphical buttons, check boxes, pull-down menu selections, pop-up menu selections, graphical toolbar icons, or dialog box options.

The window 202 further displays a “Clear” button 226. The “Clear” button 226 is configured to clear test data for whichever mode (production or debug) is currently selected. In some cases, the “Clear” button 226 may be configured to only clear data that corresponds to a currently selected one of the tabs 218, 220, 222 or 224. Alternately, the “Clear” button 226 could be configured to clear all production data or all debug data, depending on which mode has been selected via the buttons 212 and 214. Of note, all of the configurations mentioned in this paragraph may be performed “in the background”, by computer-readable code that supports the GUI 200. Alternately, the configurations could be performed as part of an application setup or configuration routine.

Instead of a “Clear” button 226, a user-selectable mechanism for separately clearing at least a portion of 1) production test data, or 2) debug test data, could be implemented in other ways. For example, the mechanism could be implemented via any or all of: one or more graphical buttons, check boxes, pull-down menu selections, pop-up menu selections, graphical toolbar icons, or dialog box options.

What is claimed is:

1. A computer-implemented method, comprising:
automatically determining whether one or more debug indicators, each of which is associated with one or more or a plurality of test data items, indicate 1) that one or more of the test data items pertain to a production mode, or 2) that one or more of the test data items pertain to a debug mode;
if one or more of the debug indicators indicates that a particular one of the test data items pertains to the production mode, allocating the particular one of the test data items to a production display of a graphical user interface (GUI);
if one or more of the debug indicators indicates that the particular one of the test data items pertains to the debug mode, allocating the particular one of the test data items to a debug display of the GUI; and
depending on whether a next test data item to be displayed pertains to the production mode or the debug mode, dynamically updating the GUI to focus on the production display or the debug display.

2. The method of claim 1, wherein the one or more debug indicators comprise tags associated with individual ones of the test data items.

3. The method of claim 1, wherein the plurality of test data items have a sequential order, and wherein one or more of the debug indicators comprise contextual information that is interspersed with the sequential order of the test data items.

4. The method of claim 1, wherein dynamically updating the GUI to focus on the production display or the debug display comprises:
dynamically swapping either 1) test data items that pertain to the production mode, or 2) test data items that pertain to the debug mode, into a common fill area of the GUI.

5. The method of claim 4, further comprising:
respectively associating the production display and the debug display with a production mode identifier and a debug mode identifier;
displaying the production mode identifier and the debug mode identifier via the GUI; and
distinguishing the production mode identifier from the debug mode identifier, to indicate whether the production display or the debug display is currently displayed in the common fill area.

6. The method of claim 1, further comprising:
respectively associating the production display and the debug display with a production mode identifier and a debug mode identifier;
displaying the production mode identifier and the debug mode identifier via the GUI; and
distinguishing the production mode identifier from the debug mode identifier, to indicate whether the GUI has been updated to focus on the production display or the debug display.

7. The method of claim 6, wherein the production mode identifier and the debug mode identifier comprise respective graphical buttons.

8. The method of claim 6, further comprising, alternately displaying the production mode identifier or the debug mode identifier.

9. The method of claim 1, further comprising:
respectively associating the production display and the debug display with a production mode selector and a debug mode selector;
displaying the production mode selector and the debug mode selector via the GUI; and
upon a user graphically clicking on one of the production mode selector or the debug mode selector, 1) updating the GUI to respectively focus on the production display or the debug display, and 2) ceasing the dynamic updates that cause the GUI to focus on the production display or the debug display.

10. The method of claim 1, further comprising:
displaying a set of graphical tabs via the GUI; and
respectively configuring the graphical tabs to access test data items that pertain to the production mode, or test data items that pertain to the debug mode, depending on whether the GUI is dynamically updated to focus on the production display or the debug display.

11. Apparatus, comprising:
computer-readable media;
computer-readable code, stored on the computer-readable media, including,
code to cause a computer to automatically determine whether one or more debug indicators, each of which is associated with one or more or a plurality of test data items, indicate 1) that one or more of the test data items pertain to a production mode, or 2) that one or more of the test data items pertain to a debug mode;
code to, if one or more of the debug indicators indicates that a particular one of the test data items pertains to the production mode, cause the computer to allocate the particular one of the test data items to a production display of a graphical user interface (GUI);
code to, if one or more of the debug indicators indicates that the particular one of the test data items pertains to the debug mode, cause the computer to allocate the particular one of the test data items to a debug display of the GUI; and
code to cause the computer to dynamically update the GUI to focus on the production display or the debug display, depending on whether a next test data item to be displayed pertains to the production mode or the debug mode.

12. The apparatus of claim 11, wherein the one or more debug indicators comprise tags associated with individual ones of the test data items.

13. The apparatus of claim 11, wherein the plurality of test data items have a sequential order, and wherein one or more of the debug indicators comprise contextual information that is interspersed with the sequential order of the test data items.

14. The apparatus of claim 11, wherein the code to cause the computer to dynamically update the GUI to focus on the production display or the debug display comprises:
code to cause the computer to dynamically swap either 1) test data items that pertain to the production mode, or 2) test data items that pertain to the debug mode, into a common fill area of the GUI.

15. The apparatus of claim 14, wherein the production display and the debug display are respectively associated with a production mode identifier and a debug mode identifier that are displayed via the GUI, the apparatus further comprising:
code to distinguish the production mode identifier from the debug mode identifier, to indicate whether the production display or the debug display is currently displayed in the common fill area.

16. The apparatus of claim 11, wherein the production display and the debug display are respectively associated with a production mode identifier and a debug mode identifier that are displayed via the GUI, the apparatus further comprising:
code to distinguish the production mode identifier from the debug mode identifier, to indicate whether GUI has been updated to focus on the production display or the debug display.

17. The apparatus of claim 16, wherein the production mode identifier and the debug mode identifier comprise respective graphical buttons.

18. The apparatus of claim 11, wherein the production display and the debug display are respectively associated with a production mode selector and a debug mode selector that are displayed via the GUI, the apparatus further comprising:
code to, upon a user graphically clicking on one of the production mode selector or the debug mode selector, cause the computer to 1) update the GUI to respectively focus on the production display or the debug display, and 2) cease the dynamic updates that cause the GUI to focus on the production display or the debug display.

19. The apparatus of claim 11, further comprising code to display a set of graphical tabs via the GUI, and to respectively configure the graphical tabs to access test data items that pertain to the production mode, or test data items that pertain to the debug mode, depending on whether the computer is caused to dynamically update the GUI to focus on the production display or the debug display.

20. The apparatus of claim 11, wherein the test data items comprise test data entries, and wherein each test data entry includes at least a test result identifier and a corresponding test result.
